(19) United States
(12) Patent Application Publication
(10) Pub. No.: US 2014/0195328 A1
(43) Pub. Date: Jul. 10, 2014

(54) ADAPTIVE EMBEDDED ADVERTISEMENT VIA CONTEXTUAL ANALYSIS AND PERCEPTUAL COMPUTING

(71) Applicants: Ron Ferens, Ramat Hasharon (IL); Gila Kamhi, Zichron Yaakov (IL); Barak Hurwitz, Kibbutz Alonim (IL); Amit Moran, Tel Aviv (IL)

(72) Inventors: Ron Ferens, Ramat Hasharon (IL); Gila Kamhi, Zichron Yaakov (IL); Barak Hurwitz, Kibbutz Alonim (IL); Amit Moran, Tel Aviv (IL)

(21) Appl. No.: 13/826,067

(22) Filed: Mar. 14, 2013

Related U.S. Application Data
(60) Provisional application No. 61/748,959, filed on Jan. 4, 2013.

(51) Int. Cl. G06Q 30/02

(52) U.S. Cl. CPC G06Q 30/0271
USPC 705/14.41; 705/14.67

(57) ABSTRACT

Technologies for adaptively embedding an advertisement into media content via contextual analysis and perceptual computing include a computing device for detecting a location to embed advertising content within media content and retrieving user profile data corresponding to a user of a computing device. Such technologies may also include determining advertising content personalized for the user based on the retrieved user profile and embedding the advertising content personalized for the user into the media content at the detected location within the media content to generate augmented media content for subsequent display to the user.

### CROSS-REFERENCE TO RELATED APPLICATION

This patent application claims priority to, and the benefit of, U.S. Provisional Patent Application Ser. No. 61/748,959, which was filed on Jan. 4, 2013.

### BACKGROUND

Mass media advertising has become a ubiquitous tool for enabling companies to reach large numbers of consumers. A popular form of mass media advertising among companies is product placement. In this form of advertising, a company typically pays to have its brand or product incorporated into mass media content (e.g., a television show, a movie, a video game, etc.). Subsequently, when a person views the mass media content, the person is exposed to the company's product or brand.

Although product placement reaches a large number of consumers, it is a static form of advertising. That is, the placement of products or brands into media content is typically done when the content is created and, as a result, cannot be changed later. Therefore, the products or brands placed within the media content typically are not customized to the consumer of the media content and cannot be changed to target different audiences without re-creating the media content.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for using a computing device to adaptively embed an advertisement into media content via contextual analysis and perceptual computing;

FIG. 2 is a simplified block diagram of at least one embodiment of an environment of the computing device of the system of FIG. 1;

FIG. 3 is an illustrative media content frame within which the computing device of FIGS. 1 and 2 may embed advertising content;

FIG. 4 is a simplified flow diagram of at least one embodiment of a method that may be executed by the computing device of FIGS. 1 and 2 for adaptively embedding an advertisement into media content via contextual analysis and perceptual computing;

FIG. 5 is a simplified flow diagram of at least one embodiment of a method that may be executed by the computing device of FIGS. 1 and 2 for monitoring user activity and updating user profile data; and

FIG. 6 is a simplified flow diagram of at least one embodiment of a method that may be executed by the computing device of FIGS. 1 and 2 for monitoring user activity during display of an embedded advertisement.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

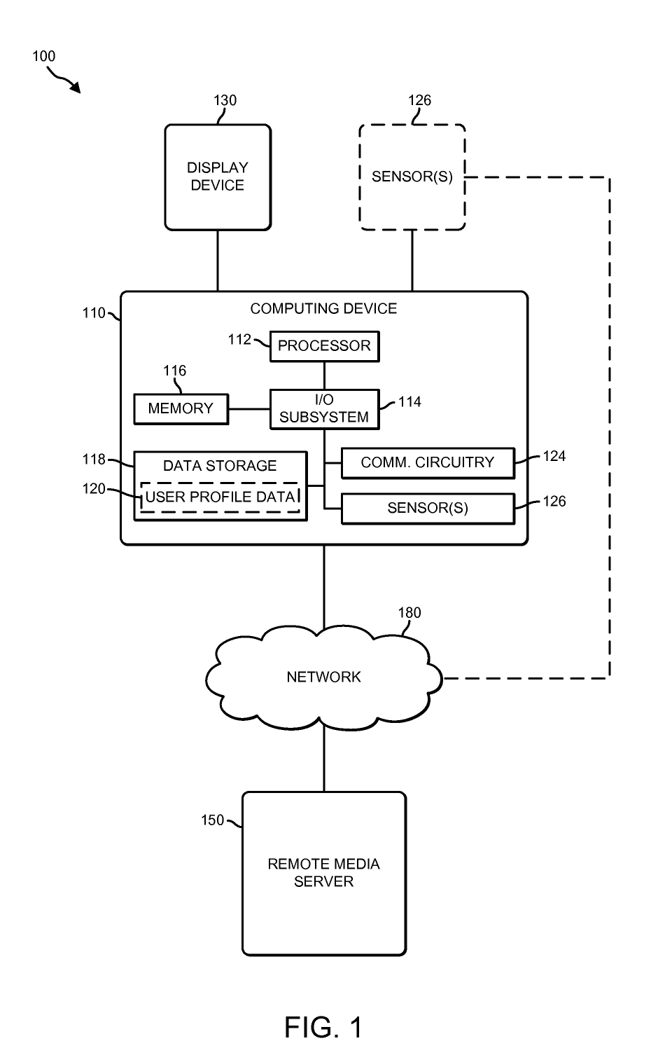

Referring now to FIG. 1, in an illustrative embodiment, a system 100 for adaptively embedding an advertisement into media content via contextual analysis and perceptual computing includes a computing device 110, one or more sensors 126, a display device 130, and a remote media server 150. In use, the computing device 110 is configured to determine a location within digital media content (e.g., video content, multimedia content, interactive web content, a video game, etc.) to adaptively embed an advertisement (e.g., a visual advertisement). The particular advertisement embedded within the media content may be selected based at least in part on, or otherwise as a function of, the identity of a user viewing and/or interacting with the media content. To do so, the computing device 110 may receive data from the one or more sensors 126 corresponding to a current activity of the user and/or the operating environmental of the computing device 110. Using the data received from the one or more sensors 126, the computing device 110 may be configured to identify the particular user viewing the media content, which may be displayed on the display device 130, in some embodiments.

Upon identifying the user viewing the media content, the computing device 110 may thereafter determine an advertisement targeted for the particular user. The computing device 110 may then embed the targeted advertisement into the media content at the determined location. Thereafter, the media content containing the embedded targeted advertisement may be displayed to the user on the display device 130, for example. In that way, advertising content within the media content may be personalized based on the particular user or users viewing and/or interacting with the media content.

The computing device 110 may be embodied as any type of computing device capable of performing the functions described herein including, but not limited to, a desktop computer, a set-top box, a smart display device, a server, a mobile phone, a smart phone, a tablet computing device, a personal digital assistant, a consumer electronic device, a laptop computer, a smart display device, a smart television, and/or any other computing device. As shown in FIG. 1, the illustrative computing device 110 includes a processor 112, a memory 116, an input/output (I/O) subsystem 114, a data storage 118, and communication circuitry 124. Of course, the computing device 110 may include other or additional components, such as those commonly found in a server and/or computer (e.g., various input/output devices), in other embodiments. Additionally, in some embodiments, one or more of the illustrative components may be incorporated in, or otherwise from a portion of, another component. For example, the memory 116, or portions thereof, may be incorporated in the processor 112 in some embodiments.

The processor 112 may be embodied as any type of processor capable of performing the functions described herein. For example, the processor 112 may be embodied as a single or multi-core processor(s), digital signal processor, microcontroller, or other processor or processing/controlling circuit. Similarly, the memory 116 may be embodied as any type of volatile or non-volatile memory or data storage capable of performing the functions described herein. In operation, the memory 116 may store various data and software used during operation of the computing device 110 such as operating systems, applications, programs, libraries, and drivers. The memory 116 is communicatively coupled to the processor 112 via the I/O subsystem 114, which may be embodied as circuitry and/or components to facilitate input/output operations with the processor 112, the memory 116, and other components of the computing device 110. For example, the I/O subsystem 114 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 114 may form a portion of a system-on-a-chip (SoC) and be incorporated, along with the processor 112, the memory 116, and other components of the computing device 110, on a single integrated circuit chip.

The communication circuitry 124 of the computing device 110 may be embodied as any type of communication circuit, device, or collection thereof, capable of enabling communications between the computing device 110, the remote media server 150, the one or more sensors 126, and/or other computing devices. The communication circuitry 124 may be configured to use any one or more communication technologies (e.g., wireless or wired communications) and associated protocols (e.g., Ethernet, Wi-Fi®, WiMAX, etc.) to effect such communication. In some embodiments, the computing device 110 and the remote media server 150 and/or the one or more sensors 126 may communicate with each other over a network 180.

The network 180 may be embodied as any number of various wired and/or wireless communication networks. For example, the network 180 may be embodied as or otherwise include a local area network (LAN), a wide area network (WAN), a cellular network, or a publicly-accessible, global network such as the Internet. Additionally, the network 180 may include any number of additional devices to facilitate communication between the computing device 110, the remote media server 150, the one or more sensors 126, and/or the other computing devices.

The data storage 118 may be embodied as any type of device or devices configured for short-term or long-term storage of data such as, for example, memory devices and circuits, memory cards, hard disk drives, solid-state drives, or other data storage devices. In the illustrative embodiment, the data storage 118 may include user profile data 120. As discussed in more detail below, the user profile data 120 maintained in the data storage 118 may include biographical information, learned behavioral patterns, and/or preferences corresponding to one or more users of the computing device 110.

The one or more sensors 126 may be embodied as any type of device or devices configured to sense characteristics of the user and/or information corresponding to the operating environment of the computing device 110. For example, in some embodiments, the one or more sensors 126 may be embodied as, or otherwise include, one or more biometric sensors configured to sense physical attributes (e.g., facial features, speech patterns, retinal patterns, etc.), behavioral characteristics (e.g., eye movement, visual focus, body movement, etc.), and/or expression characteristics (e.g., happy, sad, smiling, frowning, sleeping, surprised, excited, pupil dilation, etc.) of one or more users of the computing device 110. In some embodiments, the one or more sensors 126 may also be embodied as one or more camera sensors (e.g., cameras) configured to capture digital images of one or more users of the computing device 110. For example, the one or more sensors 126 may be embodied as one or more still camera sensors (e.g., cameras configured to capture still photographs) and/or one or more video camera sensors (e.g., cameras configured to capture moving images in a plurality of frames). In such embodiments, the digital images captured by the one or camera sensors may be analyzed to detect one or more physical attributes, behavioral characteristics, and or expression characteristics of one or more users of the computing device 110. Additionally, the one or more sensors 126 may be embodied as, or otherwise include, one or more environment sensors configured to sense environment data corresponding to the operating environment of the computing device 110. For example, in some embodiments, the one or more sensors 126 include environment sensors that are configured to sense and generate weather data, ambient light data, sound level data, location data, and/or time data corresponding to the operating environment of the computing device 110. It should be appreciated that the one or more sensors 126 may also be embodied as any other types of sensors including functionality for sensing characteristics of the user and/or information corresponding to the operating environment of the computing device 110. Additionally, although the computing device 110 includes the one or more sensors 126 in the illustrative embodiment, it should be understood that all or a portion of the one or more of the sensors 126 may be separate from the computing device 110 in other embodiments (as shown in dash line in FIG. 1).

The remote media server 150 may be embodied as any type of server or similar computing device capable of performing the functions described herein. As such, the remote media server 150 may include devices and structures commonly found in servers such as processors, memory devices, communication circuitry, and data storages, which are not shown in FIG. 1 for clarity of the description. As discussed in more detail below, the remote media server 150 is configured to provide media content (e.g., video content, multimedia content, interactive web content, video game content, etc.) to the computing device 110 for display on, for example, the display device 130. In some embodiments, the remote media server 150 is also configured to provide the computing device 110 with advertising content, which may be embedded into the media content at a location determined by the computing device 110. In other embodiments, the system 100 may include an advertisement server (not shown) configured to deliver advertisement content to the computing device 110.

The display device 130 may be embodied as any type of display device capable of performing the functions described herein. For example, the display device 130 may be embodied as any type of display device capable of displaying media content to a user including, but not limited to, a television, a smart display device, a desktop computer, a monitor, a laptop computer, a mobile phone, a smart phone, a tablet computing device, a personal digital assistant, a consumer electronic device, a server, and/or any other display device. As discussed in more detail below, the display device 130 may be configured to present (e.g., display) media content including targeted and/or personalized advertising content embedded therein. Additionally, although the display device 130 is separately connected to the computing device 110 in the illustrative embodiment of FIG. 1, it should be appreciated that the computing device 110 may instead include the display device 130 in other embodiments. In such embodiments, the computing device 110 may include, or otherwise use, any suitable display technology including, for example, a liquid crystal display (LCD), a light emitting diode (LED) display, a cathode ray tube (CRT) display, a plasma display, and/or other display usable in a computing device to display the media content.

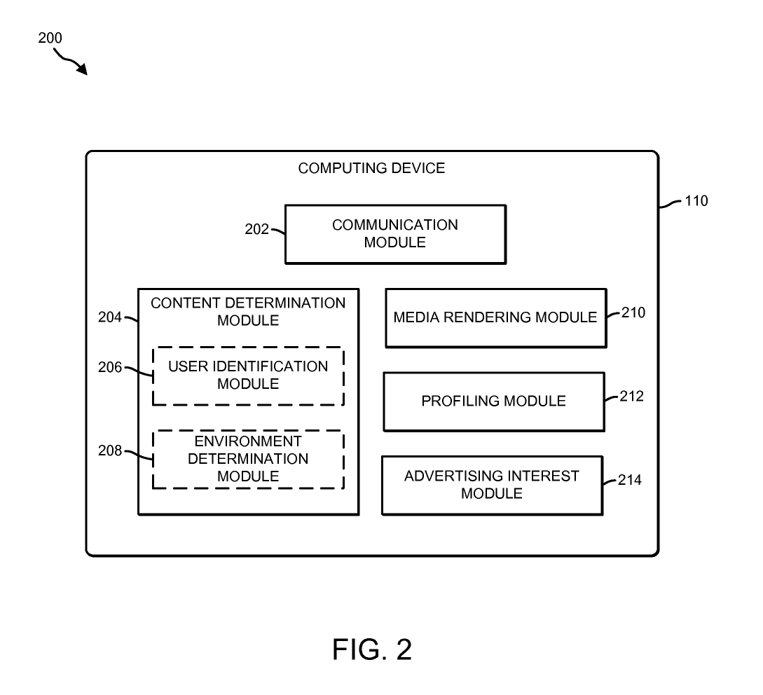

Referring now to FIG. 2, in use, the computing device 110 establishes an environment 200 during operation. The illustrative environment 200 includes a communication module 202, a content determination module 204, a media rendering module 210, a profiling module 212, and an advertising interest module 214. Each of the modules 202, 204, 210, 212, 214 of the environment 200 may be embodied as hardware, software, firmware, or a combination thereof. It should be appreciated that the computing device 110 may include other components, sub-components, modules, and devices commonly found in a server, which are not illustrated in FIG. 2 for clarity of the description.

The communication module 202 of the computing device 110 facilitates communications between components or sub-components of the computing device 110 and the remote media server 150 and/or the one or more sensors 126. For example, in some embodiments, the communication module 202 receives media content and/or advertising content from the remote media server 150. The media content provided by the remote media server 150 may be embodied as video content, multimedia content, interactive web content, and/or any other type of content to be displayed to a user of the computing device 110. As described in more detail below, the communication module 202 may also transmit data indicative of a user's interest level in advertising content embedded within media content being displayed on the display device 130. Additionally, in embodiments wherein one or more of the sensors 126 are separate from the computing device 110, the communication module 202 may be configured to receive user characteristic data and/or environment data from the one or more sensors 126 located separate from the computing device 110.

The content determination module 204 facilitates identifying one or more users of the computing device 110. To do so, the content determination module 204 may include a user identification module 206, in some embodiments. In such embodiments, the user identification module 206 may receive user characteristic data and/or physical attribute data captured by one or more of the sensors 126. As discussed, the sensors 126 may be embodied as one or more biometric sensors configured to sense physical attributes (e.g., facial features, speech patterns, retinal patterns, etc.), behavioral characteristics (e.g., eye movement, visual focus, body movement, etc.), and/or expression characteristics (e.g., happy, sad, smiling, frowning, sleeping, surprised, excited, pupil dilation, etc.) of one or more users of the computing device 110. In some embodiments, the user identification module 206 may compare the user characteristic data and/or physical attribute data received from the sensors 126 with known and/or reference user characteristic data and/or physical attribute data. Based on that comparison, the user identification module 206 may identify the particular user or users of the computing device 110. It should be appreciated that the one or more users of the computing device 110 may be identified using any suitable mechanism for identifying individuals. For example, in some embodiments, the one or more users of the computing device 110 may be identified via input received from the user (e.g., a username, a password, a personal identification number, an access code, a token, etc.).

In some embodiments, the content determination module 204 is configured to retrieve user profile data 120 corresponding to the identified user from the data storage 118. As discussed, the user profile data 120 may include biographical information, learned behavioral patterns, and/or preferences corresponding to one or more users of the computing device 110. For example, in some embodiments, the user profile data 120 may include information indicative of the identified user's gender, age, marital status, location. The user profile data 120 may also include information indicative of the identified user's preferences (e.g., brand preferences, product preferences, preferred price range preferences, merchant preferences, etc.) and/or data indicative of the identified user's learned behavioral patterns (e.g., viewing patterns, focus patterns, etc.). It should be appreciated that the user profile data 120 may include any additional or other types of data that describe a characteristic and/or an attribute of the user.

The content determination module 204 is further configured to determine or otherwise select a particular advertisement to be targeted to the identified user of the computing device 110 based at least in part on, or otherwise as a function of, the retrieved user profile data 120. To do so, the content determination module 204 may determine or otherwise select advertising content that is relevant to one or more of the identified user's biographical information, learned behavioral patterns, and/or preferences. Additionally, the content determination module 204 may use environment data together with the user profile data 120 to facilitate determining or otherwise selecting the particular advertisement to be targeted to the identified user. In that way, the content determination module 204 select a particular advertisement based, at least in part, on the context of the user. It should be appreciated that the media content and/or the advertising content may be received from the remote media server 150 in some embodiments, received from an advertisement server (not shown), or retrieved locally from the data storage 118 in other embodiments.

In embodiments wherein the particular advertisement is determined or otherwise selected based at least in part on environment data, the content determination module 204 may include an environment determination module 208. In such embodiments, the environment determination module 208 is configured to receive environment data indicative of the operating environment of the computing device 110. For example, the environment determination module 208 may receive weather data, ambient light data, sound level data, location data, and/or time data corresponding to the operating environment of the computing device 110. The environment data may be generated and received from the one or more sensors 126 or from a remote source (e.g., a weather data server). In some embodiments, the environment determination module 208 may determine the current operating environment of the computing device based at least in part on, or otherwise as a function of, the environment data generated and received from the one or more sensors 126 and/or the remote source. As discussed, the environment data may be used by the content determination module 204 to facilitate determining or otherwise selecting the particular advertisement to be targeted to the identified user.

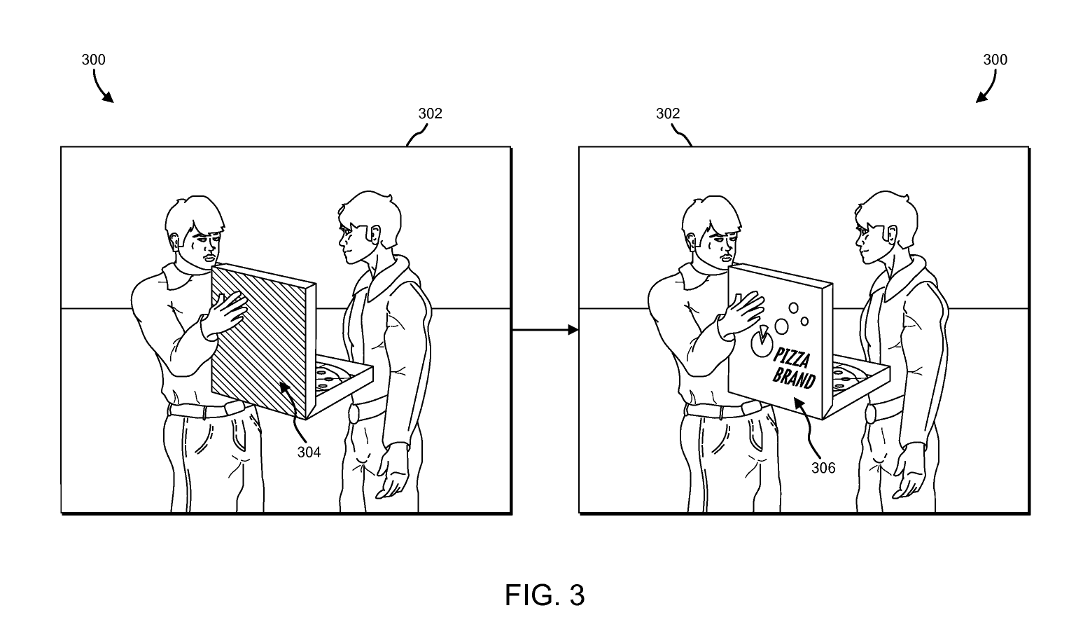

The media rendering module 210 may be configured to determine a location within the media content to embed the selected advertisement (e.g., a targeted advertisement). In some embodiments, the media rendering module 210 may be configured to automatically detect an object or area located in one or more images of the media content (e.g., a scene or frame of a video or other visual media) that may be replaced with the selected advertisement. To do so, the media rendering module 210 may be configured to utilize an object detection algorithm to locate an object or an area that may be replaced with the selected advertisement, which as discussed, may be selected as a function of one or more of a user's identity, preferences, and/or behavioral patterns. The object or area detected by the media rendering module 210 may be embodied as any object, area, device, or structure displayed in the one or more images of the media content on which advertising content may be displayed (e.g., a pizza box, a billboard, product packaging, t-shirts, containers, bumper stickers, etc.). For example, as illustratively shown in FIG. 3, the media rendering module 210 may be configured to use object detection to determine the location of a pizza box lid 304 existing in one or more images 302 of the media content 300. As discussed in more detail below, the selected advertisement 306 (e.g., a product image, logo, slogan, graphic, etc.) may be embedded within the media content 300 at the determined location of the detected object (e.g., placed on or over the pizza box lid 304). It should be appreciated that the media rendering module 210 may detect and determine the location of any type of object or objects existing in one or more images of the media content.

Referring back to FIG. 2, in some embodiments, the media rendering module 210 may also be configured to detect one or more hooks previously integrated into one or more images or sections of the media content (e.g., at the time of production or otherwise prior to distribution). In some embodiments, the hooks previously integrated into the one or more images of the media content may be embodied as metadata including location information indicative of the location of an object (or an area) within a particular image to which an advertising content may be embedded. Of course, it should be appreciated that the hooks previously integrated into the one or more images of the media content may be embodied or include other types of information (e.g., embedded instructions, flags, etc.) for identifying an object or an area within the images that advertising content may be embedded. In embodiments wherein the media content includes one or more hooks, the media rendering module 210 may detect the one or more hooks and thereafter determine the location of the object and/or area within the media content to embed the advertising content.

The media rendering module 210 also facilitates incorporating the selected advertising content for an identified user into the media content. As discussed, in some embodiments, the media rendering module 210 identifies the location of an object to be replaced, or otherwise modified, within one or more images of the media content via automatic object detection and/or one or more hooks. In such embodiments, the media rendering module 210 embeds (e.g., replaces, incorporates, superimposes, overlays, etc.) the selected advertising content into the media content at the identified location of the object to be replaced (e.g., via object detection techniques and/or hook detection). In doing so, the media rendering module 210 generates augmented media content, which may be displayed for the user on the display device 130. It should be appreciated that although the augmented media content includes the original media content modified by the targeted advertising content in the illustrative embodiment, the augmented media content may include other types of content and information in other embodiments.

The profiling module 212 facilitates updating the user profile data 120 stored in the data storage 118. To do so, the profiling module 212 may receive user characteristic data and/or physical attribute data captured by one or more of the sensors 126. The profiling module 212 may be configured to analyze the received user characteristic data and/or the physical attribute data and determine an activity of the user. For example, in some embodiments, the profiling module 212 may determine from the user characteristic data and/or the physical attribute data that the user is viewing media content being displayed on the display device 130, sleeping, operating another computing device, and/or performing any other type of activity. In some embodiments, the profiling module 212 is configured to continually receive user characteristic data and/or physical attribute data captured by one or more of the sensors 126. In such embodiments, the profiling module 212 may periodically (e.g., according to a reference time interval or in response to the occurrence of a reference event) update the user profile data 120 to include one or more of the determined activities of the user, the received user characteristic data, or the received physical attribute data. In that way, the user profile data 120 may be continuously updated and behavioral patterns of the user may be learned.

The advertising interest module 214 may be configured to determine the user's level of interest in advertising content embedded within the media content when displayed. To do so, the advertising interest module 214 may monitor the user characteristic data and/or the physical attribute data sensed by the one or more sensors 126 while the augmented media content is being displayed. For example, in some embodiments, the advertising interest module 214 may track the movement of the user's eyes relative to the display device 130. In such embodiments, the advertising interest module 214 may receive eye movement data captured by one or more of the sensors 126, for example, one or more biometric sensors. As a function of the received eye movement data, the advertising interest module 214 may determine whether the embedded advertising content was viewed by the user and what the user's reaction was to the embedded advertising content. Additionally, the advertising interest module 214 may also be configured to determine whether the user's reaction to the embedded advertising content meets or reaches a reference reaction threshold. In some embodiments, the advertising interest module 214 may further be configured to determine whether a sponsor of the embedded advertising content should be billed and/or the amount that the sponsor of the embedded advertising content should be charged based at least in part on, or otherwise as a function of, whether the user's reaction to the embedded advertising content meets or reaches the reference reaction threshold. To facilitate determining whether the embedded advertising content was viewed by the user, the user's level of reaction to the embedded advertising content, and whether the sponsor of the embedded advertising content should be charged for displaying the embedded advertising content, the advertising interest module 214 may further be configured to send the user characteristic data sensed by the one or more sensors 126, the physical attribute data sensed by the one or more sensors 126, and/or the analysis thereof to a remote server (e.g., an advertisement server and/or the remote media server 150) for further analysis and/or processing. In such embodiments, the remote server may determine whether the embedded advertising content was viewed by the user, the user's level of reaction to the embedded advertising content, and whether the sponsor of the embedded advertising content should be charged for displaying the embedded advertising content.

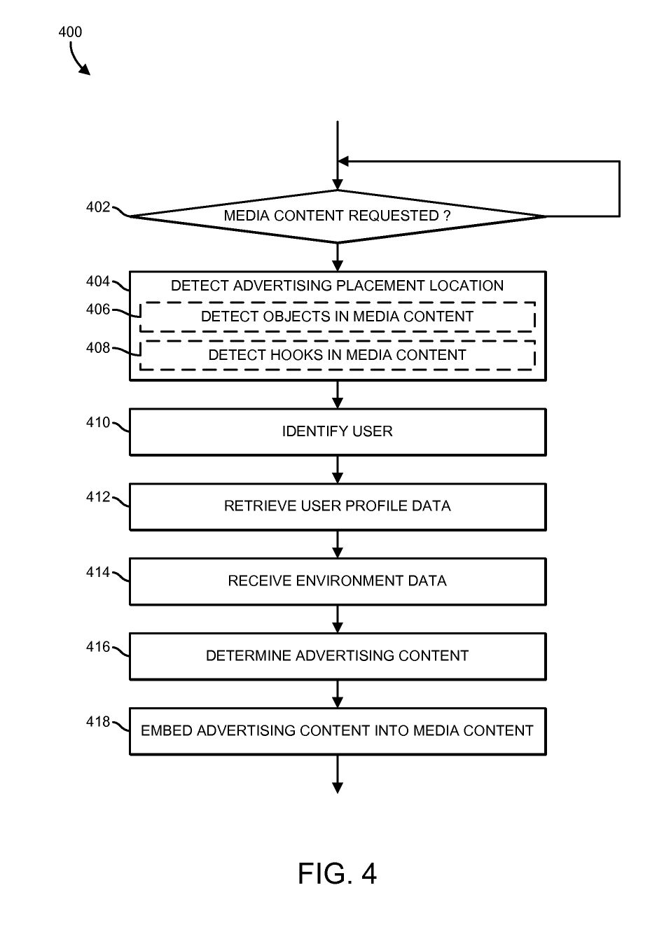

Referring now to FIG. 4, in use, the computing device 110 of the system 100 may execute a method 400 for adaptively embedding an advertisement into media content via contextual analysis and perceptual computing. The method 400 begins with block 402 in which the computing device 110 determines whether media content has been requested. To do so, in some embodiments, one or more inputs (e.g. a touch screen, a keyboard, a mouse, a user interface, a voice recognition interface, remote control commands, etc.) of the computing device 110 are monitored to determine whether a user has requested media content. If, in block 402, it is determined that media content has been requested, the method 400 advances to block 404. If, however, the computing device 110 determines instead that media content has not been requested, the method 400 loops back to block 402 to continue monitoring for a media content request.

In block 404, the computing device 110 detects a location within the media content at which to embed targeted advertising content. To do so, in some embodiments in block 406, the computing device 110 automatically detects an object located in one or more images of the media content that may be replaced (e.g., overlaid, superimposed, etc.) with the selected advertisement. In some embodiments, the computing device 110 may utilize an object detection algorithm to locate the object. As such, the computing device 110 may perform an image analysis procedure (e.g., feature detection, edge detection, computer vision, machine vision, etc.) to detect an object or an area of interest. For example, the computing device 110 may detect one or more edges, reference colors, hashing, highlighting, or any feature displayed in the images to identify one or more objects of interest (e.g., any object, area, device, or structure displayed in the one or more images of the media content on which advertising content may be displayed). In such embodiments, the computing device 110 determines the location of the identified object within the particular images. Additionally or alternatively, at block 408, the computing device 110 detects, in some embodiments, one or more hooks previously integrated or embedded into one or more images or sections of the media content (e.g., at the time of production or otherwise prior to distribution). In such embodiments, the computing device 110 determines the location of the one or more hooks identified within the media content. After determining the location within the media content at which to embed the targeted advertising content, the method 400 advances to block 410.

In block 410, the computing device 110 identifies the current user (or users) of the computing device 110. To do so, the computing device 110 receives, in some embodiments, user characteristic data and/or physical attribute data captured by one or more of the sensors 126. In some embodiments, the computing device 110 compares the received user characteristic data and/or physical attribute data to known and/or reference user characteristic data and/or physical attribute data in order to identify the particular user of the computing device 110. After identifying the user of the computing device 110, the method 400 advances to block 412.

In block 412, the computing device 110 retrieves user profile data 120 corresponding to the identified user from the data storage 118. The user profile data 120 may include biographical information, learned behavioral patterns, and/or preferences corresponding to one or more users of the computing device 110.

In block 414, the computing device 110 receives environment data indicative of the operating environment of the computing device 110. For example, the content determination module 204 may receive weather data, ambient light data, sound level data, location data, and/or time data corresponding to the operating environment of the computing device 110. In some embodiments, the computing device 110 receives the environment data from one or more of the sensors 126.

Subsequently, in block 416, the computing device 110 determines or otherwise selects a particular advertisement to be targeted to the identified user. To do so, the computing device 110 selects advertising content that is relevant to one or more of the identified user's biographical information, learned behavioral patterns, and/or preferences as of function of the retrieved user profile data 120. Additionally or alternatively, in some embodiments, the computing device 110 selects advertising content based at least in part on, or otherwise as a function of, the user profile data 120 and the received environment data. In that way, the computing device 110 selects the particular advertisement to be embedded within the media content based at least in part on the context of the user. In some embodiments, the computing device 110 may send the user profile data 120 and/or the received environment data to a remote advertising server (not shown) for selection of the particular advertisement to embed. After determining the particular advertisement to embed within the media content, the method 400 advances to block 418.

In block 418, the computing device 110 embeds the selected advertising content into the media content at the determined location. For example, in some embodiments, the computing device 110 embeds (e.g., replaces, incorporates, superimposes, overlays, etc.) the selected advertising content into the media content at the identified location of the object to be replaced. In doing so, the computing device 110 generates augmented media content, which as discussed, includes the original media content having the selected advertising content embedded therein.

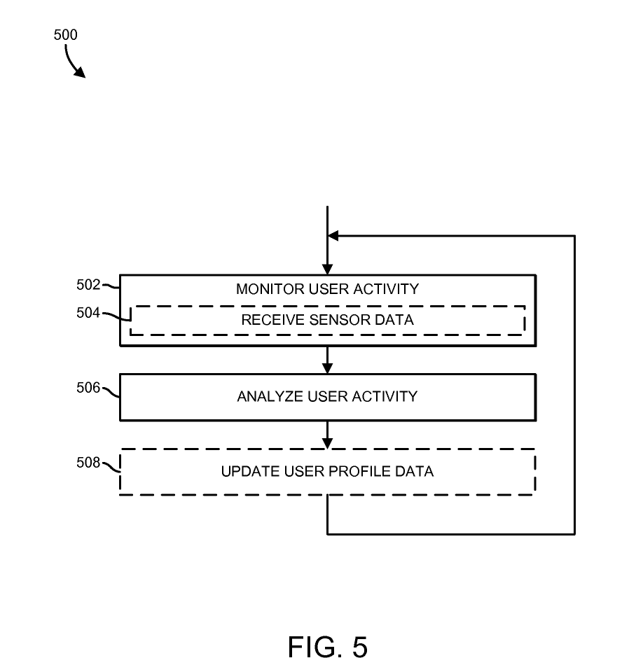

Referring now to FIG. 5, in use, the computing device 110 of the system 100 may execute a method 500 for monitoring user activity and updating user profile data. The method 500 begins with block 502 in which the computing device 110 monitors the activity of a user of the computing device 110. To do so, at block 504, the computing device 110 receives user characteristic data and/or physical attribute data captured by one or more of the sensors 126, in some embodiments. The method 500 then advances to block 506.

In block 506, the computing device 110 analyzes the received user characteristic data and/or the physical attribute data and determines an activity of the user therefrom. For example, in some embodiments, the computing device 110 determines from the received user characteristic data and/or the physical attribute data that the user is viewing the media content being displayed on the display device 130, sleeping, operating another computing device, and/or performing any other type of activity. After determining the activity of the user, the method 500 advances to block 508.

At block 508, in some embodiments, the computing device 110 updates the user profile data 120 to include one or more of the determined activities of the user, the received user characteristic data, and/or the received physical attribute data. In some embodiments, the computing device 110 updates the user profile data 120 periodically (e.g., according to a reference time interval or in response to the occurrence of a reference event). Additionally or alternatively, the computing device 110 updates the user profile data 120 continuously (e.g., upon the receipt of new user characteristic and/or physical attribute data). After updating the user profile data 120, the method 500 loops back to block 502 to continue monitoring the user's activity.

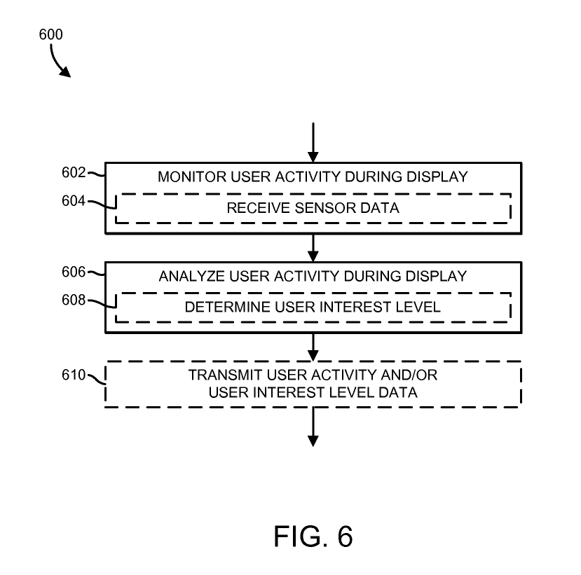

Referring now to FIG. 6, in use, the computing device 110 of the system 100 may execute a method 600 for monitoring user activity during display of an embedded advertisement. The method 600 begins with block 602 in which the computing device 110 monitors the activity of a user of the computing device 110 during display of augmented media content (e.g., media content that includes the original media content and advertising content embedded therein). To do so, at block 604, the computing device 110 receives user characteristic data and/or physical attribute data captured by one or more of the sensors 126 during the display of the augmented media content on a display device such as, for example, the display device 130. The method 600 then advances to block 606.

In block 606, the computing device 110 analyzes the received user characteristic data and/or the physical attribute data and determines an activity of the user therefrom. For example, in some embodiments, the computing device 110 determines from the received user characteristic data and/or the physical attribute data that the user is viewing the media content being displayed on the display device 130, sleeping, operating another computing device, and/or performing any other type of activity. In some embodiments, the computing device 110 determines may determine the user's interest level in the advertising content being displayed as a function of the user characteristic data and/or the physical attribute data captured by one or more of the sensors 126 during the display of the augmented media content. For example, the computing device 110 may determine the user's reaction to the embedded advertising content when it is displayed on the display device 130. Additionally or alternatively, the computing device may determine whether the user's reaction to the embedded advertising content meets or reaches a reference reaction threshold. In some embodiments, based on that determination, the computing device 110 may determine whether a sponsor of the advertising content (e.g., the company or entity advertising a product or a service) should be charged for displaying the embedded advertising content to the user. After determining the activity and/or interest level of the user, the method 600 advances to block 610.

At block 610, in some embodiments, the computing device 110 transmits the user activity and/or interest level to a remote device (e.g., an advertisement server and/or the remote media server 150) for further analysis and/or processing. For example, the computing device 110 may transmit the user characteristic data sensed by the one or more sensors 126, the physical attribute data sensed by the one or more sensors 126, and/or the analysis thereof to a remote device. In such embodiments, the remote device may facilitate determining whether the embedded advertising content was viewed by the user, the user's level of reaction to the embedded advertising content, and whether the sponsor of the embedded advertising content should be charged for displaying the embedded advertising content.

It should be appreciated that all or a portion of the functionality of the computing device 110 described above may instead be performed by the remote media server and/or another remote server. For example, in some embodiments, a remote advertising server (not shown) may determine a location of an object or an area (e.g., object detection and/or previously embedded hooks) within media content at which advertising content may be embedded. In such embodiments, the remote advertising server may receive user characteristic data, physical attribute data, and/or environment data sensed by the one or more sensors 126. Using that information, the remote advertising server may analyze the received data and identify a user therefrom. The remote advertising server may also select advertising content relevant to the identified user based at least in part on, or otherwise as a function of, corresponding user profile data, which may be maintained on the remote advertising server or locally on the computing device 110. Subsequently, the remote advertising server may embed (e.g., replace, incorporate, superimpose, overlay, etc.) the selected advertising content into the media content at the identified location of the object or area to be replaced. In doing so, the remote advertising server generates augmented media content, which may be sent to the computing device for display on a display device such as, for example, the display device 130.

### EXAMPLES

Illustrative examples of the technologies disclosed herein are provided below. An embodiment of the technologies may include any one or more, and any combination of, the examples described below.

Example 1 includes a computing device to adaptively embed visual advertising content into media content, the computing device includes a content determination module to (i) retrieve user profile data corresponding to a user of the computing device, and (ii) determine advertising content personalized for the user as a function of the retrieved user profile data; and a media rendering module to (i) detect a location within an image of the media content at which to embed visual advertising content, and (ii) embed the visual advertising content personalized for the user into the media content at the detected location within the media content to generate augmented media content.

Example 2 includes the subject matter of Example 1, and wherein to detect a location within an image of the media content at which to embed visual advertising content includes to detect an object within the image of the media content; and wherein to embed the visual advertising content personalized for the user into the media content to generate augmented media content includes to embed the visual advertising content personalized for the user onto the detected object within the image of the media content to generate the augmented media content.

Example 3 includes the subject matter of any of Examples 1 and 2, and wherein to detect an object within the image of the media content includes to perform an image analysis procedure on the image to detect the object.

Example 4 includes the subject matter of any of Examples 1-3, and wherein to perform an image analysis procedure on the image includes to perform at least one of a feature detection procedure, a machine vision procedure, or a computer vision procedure on the image to detect the object.

Example 5 includes the subject matter of any of Examples 1-4, and wherein to detect a location within an image of the media content at which to embed visual advertising content includes to detect a hook embedded within the media content; and wherein to embed the visual advertising content personalized for the user into the media content to generate augmented media content includes to embed the visual advertising content personalized for the user into the media content as a function of the hook to generate the augmented media content.

Example 6 includes the subject matter of any of Examples 1-5, and wherein the hook embedded within the media content includes metadata indicative of a location of at least one of an object or an area within the image of the media content at which to embed the visual advertising content.

Example 7 includes the subject matter of any of Examples 1-6, and wherein the content determination module is further to (i) receive user characteristic data captured by at least one sensor, and (ii) identify the user as a function of the user characteristic data; wherein to retrieve user profile data corresponding to a user of the computing device includes to retrieve the user profile data corresponding to the identified user; and wherein to determine advertising content personalized for the user as a function of the retrieved user profile data includes to determine advertising content personalized for the user as a function of the retrieved user profile data corresponding to the identified user.

Example 8 includes the subject matter of any of Examples 1-7, and wherein to receive user characteristic data captured by at least one sensor includes to receive user characteristic data captured by at least one biometric sensor.

Example 9 includes the subject matter of any of Examples 1-8, and wherein the user profile data includes at least one of biographical information that corresponds to the user, a learned behavioral pattern that corresponds to the user, or preferences of the user.

Example 10 includes the subject matter of any of Examples 1-9, and further including a profiling module to (i) receive user characteristic data captured by at least one sensor, (ii) analyze the user characteristic data captured by the at least one sensor, (iii) determine an activity of the user as a function of the analyzed user characteristic data, and (iv) update the user profile data as a function of the determined activity of the user.

Example 11 includes the subject matter of any of Examples 1-10, and further including an advertising interest module to determine a level of interest of the user in the embedded visual advertising content.

Example 12 includes the subject matter of any of Examples 1-11, and wherein the advertising interest module further to track eye movement of the user relative to a display device upon which the augmented media content is displayed via user eye movement data captured by at least one biometric sensor.

Example 13 includes the subject matter of any of Examples 1-12, and wherein to determine a level of interest of the user in the embedded visual advertising content includes to determine a level of interest of the user in the embedded visual advertising content as a function of the eye movement data captured by the at least one biometric sensor.

Example 14 includes the subject matter of any of Examples 1-13, and wherein the advertising interest module further to (i) determine whether the embedded visual advertising content was viewed by the user as a function of the eye movement data captured by the at least one biometric sensor, (ii) determine a reaction of the user to the embedded visual advertising content in response to a determination that the embedded visual advertising content was viewed by the user, (iii) determine whether the reaction to the embedded visual advertising content meets a reference reaction threshold, and (iv) determine whether to charge a sponsor of the embedded visual advertising content as a function of the reference reaction threshold.

Example 15 includes the subject matter of any of Examples 1-14, and wherein the content determination module is further to receive environment data corresponding to an operating environment of the computing device; and wherein to determine advertising content personalized for the user includes to determine advertising content personalized for the user as a function of the retrieved user profile data and the received environment data.

Example 16 includes the subject matter of any of Examples 1-15, and wherein to receive environment data corresponding to an operating environment of the computing device includes to receive at least one of weather data, ambient light data, sound level data, location data, or time data captured by at least environment one sensor.

Example 17 includes the subject matter of any of Examples 1-16, and further including a communication module to (i) receive the media content from a remote media server; and (ii) receive the visual advertising content from the remote media server.

Example 18 includes the subject matter of any of Examples 1-17, and wherein to embed the visual advertising content personalized for the user into the media content at the detected location within the media content includes to at least one of superimpose, overlay, replace, or incorporate the visual advertising content personalized for the user at the detected location within the media content.

Example 19 includes a method for adaptively embedding visual advertising content into media content, the method includes detecting, on a computing device, a location within an image of the media content at which to embed visual advertising content; retrieving, on the computing device, user profile data corresponding to a user of the computing device; determining, on the computing device, advertising content personalized for the user as a function of the retrieved user profile data; and embedding, on the computing device, the visual advertising content personalized for the user into the media content at the detected location within the media content to generate augmented media content.

Example 20 includes the subject matter of Example 19, and wherein detecting a location within an image of the media content at which to embed advertising content includes detecting an object within the image of the media content; and wherein embedding the visual advertising content personalized for the user into the media content to generate augmented media content includes embedding the visual advertising content personalized for the user onto the detected object within the image of the media content to generate the augmented media content.

Example 21 includes the subject matter of any of Examples 19 and 20, and wherein detecting an object within the image of the media content includes performing an image analysis procedure on the image to detect the object.

Example 22 includes the subject matter of any of Examples 19-21, and wherein performing an image analysis procedure on the image includes performing at least one of a feature detection procedure, a machine vision procedure, or a computer vision procedure on the image to detect the object.

Example 23 includes the subject matter of any of Examples 19-22, and wherein detecting a location within an image of the media content at which to embed visual advertising content includes detecting a hook embedded within the media content; and wherein embedding the visual advertising content personalized for the user into the media content to generate augmented media content includes embedding the visual advertising content personalized for the user into the media content as a function of the hook to generate the augmented media content.

Example 24 includes the subject matter of any of Examples 19-23, and wherein the hook embedded within the media content includes metadata indicative of a location of at least one of an object or an area within the image of the media content at which to embed the visual advertising content.

Example 25 includes the subject matter of any of Examples 19-24, and further including receiving, on the computing device, user characteristic data captured by at least one sensor; identifying, on the computing device, the user as a function of the user characteristic data; wherein retrieving user profile data corresponding to a user of the computing device includes retrieving the user profile data corresponding to the identified user; and wherein determining advertising content personalized for the user as a function of the retrieved user profile data includes determining advertising content personalized for the user as a function of the retrieved user profile data corresponding to the identified user.

Example 26 includes the subject matter of any of Examples 19-25, and wherein receiving user characteristic data captured by at least one sensor includes receiving user characteristic data captured by at least one biometric sensor.

Example 27 includes the subject matter of any of Examples 19-26, and wherein the user profile data includes at least one of biographical information corresponding to the user, learned behavioral patterns corresponding to the user, or preferences of the user.

Example 28 includes the subject matter of any of Examples 19-27, and further including receiving, on the computing device, user characteristic data captured by at least one sensor; analyzing, on the computing device, the user characteristic data captured by the at least one sensor; determining, on the computing device, an activity of the user as a function of the analyzed user characteristic data; and updating, on the computing device, the user profile data as a function of the determined activity of the user.

Example 29 includes the subject matter of any of Examples 19-28, and further including determining, on the computing device, a level of interest of the user in the visual embedded advertising content.

Example 30 includes the subject matter of any of Examples 19-29, and further including tracking, on the computing device, eye movement of the user relative to a display device displaying the augmented media content via user eye movement data captured by at least one biometric sensor.

Example 31 includes the subject matter of any of Examples 19-30, and wherein determining a level of interest of the user in the embedded visual advertising content includes determining a level of interest of the user in the embedded visual advertising content as a function of the eye movement data captured by the at least one biometric sensor.

Example 32 includes the subject matter of any of Examples 19-31, and further includes determining, on the computing device, whether the embedded visual advertising content was viewed by the user as a function of the eye movement data captured by the at least one biometric sensor; determining, on the computing device, a reaction of the user to the embedded visual advertising content in response to determining that the embedded advertising content was viewed by the user; determining, on the computing device, whether the reaction to the embedded visual advertising content meets a reference reaction threshold; and determining, on the computing device, whether to charge a sponsor of the embedded visual advertising content as a function of the reference reaction threshold.

Example 33 includes the subject matter of any of Examples 19-32, and further includes receiving, on the computing device, environment data corresponding to an operating environment of the computing device; and wherein determining advertising content personalized for the user as a function of the retrieved user profile data includes determining advertising content personalized for the user as a function of the retrieved user profile data and the received environment data.

Example 34 includes the subject matter of any of Examples 19-33, and wherein receiving environment data corresponding to an operating environment of the computing device includes receiving at least one of weather data, ambient light data, sound level data, location data, or time data captured by at least environment one sensor.

Example 35 includes the subject matter of any of Examples 19-34, and further includes receiving, on the computing device, the media content from a remote media server; and receiving, on the computing device, the visual advertising content from the remote media server.

Example 36 includes the subject matter of any of Examples 19-35, and wherein embedding the visual advertising content personalized for the user into the media content at the detected location within the media content includes at least one of superimposing, overlaying, replacing, or incorporating the visual advertising content personalized for the user at the detected location within the media content.

Example 37 includes a computing device to adaptively embed visual advertising content into media content, the computing device includes a processor; and a memory having stored therein a plurality of instructions that when executed by the processor cause the computing device to perform the method of any of Examples 19-36.

Examples 38 includes one or more machine readable media including a plurality of instructions stored thereon that in response to being executed result in a computing device performing the method of any of Examples 19-36.

Example 39 includes a computing device for adaptively embedding visual advertising content into media content, the computing device includes means for detecting a location within an image of the media content at which to embed visual advertising content; means for retrieving user profile data corresponding to a user of the computing device; means for determining advertising content personalized for the user as a function of the retrieved user profile data; and means for embedding the visual advertising content personalized for the user into the media content at the detected location within the media content to generate augmented media content.

Example 40 includes the subject matter of Example 39, and wherein the means for detecting a location within an image of the media content at which to embed advertising content includes means for detecting an object within the image of the media content; and wherein the means for embedding the visual advertising content personalized for the user into the media content to generate augmented media content includes means for embedding the visual advertising content personalized for the user onto the detected object within the image of the media content to generate the augmented media content.

Example 41 includes the subject matter of any of Examples 39 and 40, and wherein the means for detecting an object within the image of the media content includes means for performing an image analysis procedure on the image to detect the object.

Example 42 includes the subject matter of any of Examples 39-41, and wherein the means for performing an image analysis procedure on the image includes means for performing at least one of a feature detection procedure, a machine vision procedure, or a computer vision procedure on the image to detect the object.

Example 43 includes the subject matter of any of Examples 39-42, and wherein the means for detecting a location within an image of the media content at which to embed visual advertising content includes means for detecting a hook embedded within the media content; and wherein the means for embedding the visual advertising content personalized for the user into the media content to generate augmented media content includes means for embedding the visual advertising content personalized for the user into the media content as a function of the hook to generate the augmented media content.

Example 44 includes the subject matter of any of Examples 39-43, and wherein the hook embedded within the media content includes metadata indicative of a location of at least one of an object or an area within the image of the media content at which to embed the visual advertising content.

Example 45 includes the subject matter of any of Examples 39-44, and further includes means for receiving user characteristic data captured by at least one sensor; means for identifying the user as a function of the user characteristic data; wherein the means for retrieving user profile data corresponding to a user of the computing device includes means for retrieving the user profile data corresponding to the identified user; and wherein the means for determining advertising content personalized for the user as a function of the retrieved user profile data includes means for determining advertising content personalized for the user as a function of the retrieved user profile data corresponding to the identified user.

Example 46 includes the subject matter of any of Examples 39-45, and wherein the means for receiving user characteristic data captured by at least one sensor includes means for receiving user characteristic data captured by at least one biometric sensor.

Example 47 includes the subject matter of any of Examples 39-46, and wherein the user profile data includes at least one of biographical information corresponding to the user, learned behavioral patterns corresponding to the user, or preferences of the user.

Example 48 includes the subject matter of any of Examples 39-47, and further includes means for receiving user characteristic data captured by at least one sensor; means for analyzing the user characteristic data captured by the at least one sensor; means for determining an activity of the user as a function of the analyzed user characteristic data; and means for updating the user profile data as a function of the determined activity of the user.

Example 49 includes the subject matter of any of Examples 39-48, and further includes means for determining a level of interest of the user in the visual embedded advertising content.

Example 50 includes the subject matter of any of Examples 39-49, and further including means for tracking eye movement of the user relative to a display device displaying the augmented media content via user eye movement data captured by at least one biometric sensor.

Example 51 includes the subject matter of any of Examples 39-50, and wherein the means for determining a level of interest of the user in the embedded visual advertising content includes means for determining a level of interest of the user in the embedded visual advertising content as a function of the eye movement data captured by the at least one biometric sensor.

Example 52 includes the subject matter of any of Examples 39-51, and further including means for determining whether the embedded visual advertising content was viewed by the user as a function of the eye movement data captured by the at least one biometric sensor; means for determining a reaction of the user to the embedded visual advertising content in response to determining that the embedded advertising content was viewed by the user; means for determining whether the reaction to the embedded visual advertising content meets a reference reaction threshold; and means for determining whether to charge a sponsor of the embedded visual advertising content as a function of the reference reaction threshold.

Example 53 includes the subject matter of any of Examples 39-52, and further including means for receiving environment data corresponding to an operating environment of the computing device; and wherein the means for determining advertising content personalized for the user as a function of the retrieved user profile data includes means for determining advertising content personalized for the user as a function of the retrieved user profile data and the received environment data.

Example 54 includes the subject matter of any of Examples 39-53, and wherein the means for receiving environment data corresponding to an operating environment of the computing device includes means for receiving at least one of weather data, ambient light data, sound level data, location data, or time data captured by at least environment one sensor.

Example 55 includes the subject matter of any of Examples 39-54, and further including means for receiving the media content from a remote media server; and means for receiving the visual advertising content from the remote media server.

Example 56 includes the subject matter of any of Examples 39-55, and wherein the means for embedding the visual advertising content personalized for the user into the media content at the detected location within the media content includes means for at least one of superimposing, overlaying, replacing, or incorporating the visual advertising content personalized for the user at the detected location within the media content.

1. A computing device to adaptively embed visual advertising content into media content, the computing device comprising:
a content determination module to (i) retrieve user profile data corresponding to a user of the computing device, and (ii) determine advertising content personalized for the user as a function of the retrieved user profile data; and
a media rendering module to (i) detect a location within an image of the media content at which to embed visual advertising content, and (ii) embed the visual advertising content personalized for the user into the media content at the detected location within the media content to generate augmented media content.

2. The computing device of claim 1, wherein to detect a location within an image of the media content at which to embed visual advertising content comprises to detect an object within the image of the media content; and
wherein to embed the visual advertising content personalized for the user into the media content to generate augmented media content comprises to embed the visual advertising content personalized for the user onto the detected object within the image of the media content to generate the augmented media content.

3. The computing device of claim 1, wherein to detect a location within an image of the media content at which to embed visual advertising content comprises to detect a hook embedded within the media content; and
wherein to embed the visual advertising content personalized for the user into the media content to generate augmented media content comprises to embed the visual advertising content personalized for the user into the media content as a function of the hook to generate the augmented media content.

4. The computing device of claim 3, wherein the hook embedded within the media content comprises metadata indicative of a location of at least one of an object or an area within the image of the media content at which to embed the visual advertising content.

5. The computing device of claim 1, wherein the content determination module is further to (i) receive user characteristic data captured by at least one sensor, and (ii) identify the user as a function of the user characteristic data;
wherein to retrieve user profile data corresponding to a user of the computing device comprises to retrieve the user profile data corresponding to the identified user; and
wherein to determine advertising content personalized for the user as a function of the retrieved user profile data comprises to determine advertising content personalized for the user as a function of the retrieved user profile data corresponding to the identified user.

6. The computing device of claim 5, wherein to receive user characteristic data captured by at least one sensor comprises to receive user characteristic data captured by at least one biometric sensor.

7. The computing device of claim 1, wherein the user profile data comprises at least one of biographical information that corresponds to the user, a learned behavioral pattern that corresponds to the user, or preferences of the user.

8. The computing device of claim 7, further comprising a profiling module to (i) receive user characteristic data captured by at least one sensor, (ii) analyze the user characteristic data captured by the at least one sensor, (iii) determine an activity of the user as a function of the analyzed user characteristic data, and (iv) update the user profile data as a function of the determined activity of the user.

9. The computing device of claim 1, further comprising an advertising interest module to determine a level of interest of the user in the embedded visual advertising content.

10. The computing device of claim 9, wherein the advertising interest module further to track eye movement of the user relative to a display device upon which the augmented media content is displayed via user eye movement data captured by at least one biometric sensor; and
wherein to determine a level of interest of the user in the embedded visual advertising content comprises to determine a level of interest of the user in the embedded visual advertising content as a function of the eye movement data captured by the at least one biometric sensor.

11. The computing device of claim 9, wherein the advertising interest module further to (i) track eye movement of the user relative to a display device upon which the augmented media content is displayed via user eye movement data captured by at least one biometric sensor, (ii) determine whether the embedded visual advertising content was viewed by the user as a function of the eye movement data captured by the at least one biometric sensor, (iii) determine a reaction of the user to the embedded visual advertising content in response to a determination that the embedded visual advertising content was viewed by the user, (iv) determine whether the reaction to the embedded visual advertising content meets a reference reaction threshold, and (v) determine whether to charge a sponsor of the embedded visual advertising content as a function of the reference reaction threshold.

12. The computing device of claim 1 wherein the content determination module is further to receive environment data corresponding to an operating environment of the computing device; and
wherein to determine advertising content personalized for the user comprises to determine advertising content personalized for the user as a function of the retrieved user profile data and the received environment data.

13. The computing device of claim 12, wherein to receive environment data corresponding to an operating environment of the computing device comprises to receive at least one of weather data, ambient light data, sound level data, location data, or time data captured by at least environment one sensor.

14. The computing device of claim 1, further comprising a communication module to (i) receive the media content from a remote media server; and (ii) receive the visual advertising content from the remote media server.

15. One or more machine readable media comprising a plurality of instructions stored thereon that in response to being executed result in a computing device:
detecting a location within an image of the media content at which to embed visual advertising content;
retrieving user profile data corresponding to a user of the computing device;
determining advertising content personalized for the user as a function of the retrieved user profile data; and
embedding the visual advertising content personalized for the user into the media content at the detected location within the media content to generate augmented media content.

16. The one or more machine readable media of claim 15, wherein detecting a location within an image of the media content at which to embed advertising content comprises detecting an object within the image of the media content; and
wherein embedding the visual advertising content personalized for the user into the media content to generate augmented media content comprises embedding the visual advertising content personalized for the user onto the detected object within the image of the media content to generate the augmented media content.

17. The one or more machine readable media of claim 15, wherein detecting a location within an image of the media content at which to embed visual advertising content comprises detecting a hook embedded within the media content; and
wherein embedding the visual advertising content personalized for the user into the media content to generate augmented media content comprises embedding the visual advertising content personalized for the user into the media content as a function of the hook to generate the augmented media content.

18. The one or more machine readable media of claim 15, wherein the plurality of instructions further result in the computing device:
receiving user characteristic data captured by at least one sensor;
identifying the user as a function of the user characteristic data;
wherein retrieving user profile data corresponding to a user of the computing device comprises retrieving the user profile data corresponding to the identified user; and
wherein determining advertising content personalized for the user as a function of the retrieved user profile data comprises determining advertising content personalized for the user as a function of the retrieved user profile data corresponding to the identified user.

19. The one or more machine readable media of claim 15, wherein the plurality of instructions further result in the computing device determining a level of interest of the user in the visual embedded advertising content.

20. The one or more machine readable media of claim 19, wherein the plurality of instructions further result in the computing device tracking eye movement of the user relative to a display device displaying the augmented media content via user eye movement data captured by at least one biometric sensor; and
wherein determining a level of interest of the user in the embedded visual advertising content comprises determining a level of interest of the user in the embedded visual advertising content as a function of the eye movement data captured by the at least one biometric sensor.

21. The one or more machine readable media of claim 15, wherein the plurality of instructions further result in the computing device:
tracking eye movement of the user relative to a display device displaying the augmented media content via user eye movement data captured by at least one biometric sensor;
determining whether the embedded visual advertising content was viewed by the user as a function of the eye movement data captured by the at least one biometric sensor;
determining a reaction of the user to the embedded visual advertising content in response to determining that the embedded advertising content was viewed by the user;
determining whether the reaction to the embedded visual advertising content meets a reference reaction threshold; and
determining whether to charge a sponsor of the embedded visual advertising content as a function of the reference reaction threshold.

22. The one or more machine readable media of claim 15, wherein the plurality of instructions further result in the computing device receiving environment data corresponding to an operating environment of the computing device; and
wherein determining advertising content personalized for the user as a function of the retrieved user profile data comprises determining advertising content personalized for the user as a function of the retrieved user profile data and the received environment data.

23. A method for adaptively embedding visual advertising content into media content, the method comprising:
detecting, on a computing device, a location within an image of the media content at which to embed visual advertising content;
retrieving, on the computing device, user profile data corresponding to a user of the computing device;
determining, on the computing device, advertising content personalized for the user as a function of the retrieved user profile data; and
embedding, on the computing device, the visual advertising content personalized for the user into the media content at the detected location within the media content to generate augmented media content.

24. The method of claim 23, wherein detecting a location within an image of the media content at which to embed advertising content comprises detecting an object within the image of the media content; and
wherein embedding the visual advertising content personalized for the user into the media content to generate augmented media content comprises embedding the visual advertising content personalized for the user onto the detected object within the image of the media content to generate the augmented media content.

25. The method of claim 23, wherein detecting a location within an image of the media content at which to embed visual advertising content comprises detecting a hook embedded within the media content; and
wherein embedding the visual advertising content personalized for the user into the media content to generate augmented media content comprises embedding the visual advertising content personalized for the user into the media content as a function of the hook to generate the augmented media content.
